(19) United States
(12) Patent Application Publication
(10) Pub. No.: US 2025/0062973 A1
(43) Pub. Date: Feb. 20, 2025

(54) SYSTEMS AND METHODS FOR RADIO ACCESS NETWORK (RAN) VISIBLE QUALITY OF EXPERIENCE (QoE) MEASUREMENT IN DUAL CONNECTIVITY ARCHITECTURE

(71) Applicant: ZTE Corporation, Shenzhen (CN)

(72) Inventors: Man ZHANG, Shenzhen (CN); Yin GAO, Shenzhen (CN); Dapeng LI, Shenzhen (CN); Zhuang LIU, Shenzhen (CN); Yansheng LIU, Shenzhen (CN)

(73) Assignee: ZTE Corporation, Shenzhen (CN)

(21) Appl. No.: 18/737,650

(22) Filed: Jun. 7, 2024

Related U.S. Application Data
(63) Continuation of application No. PCT/CN2022/107472, filed on Jul. 22, 2022.

(51) Int. Cl. H04L 41/5067; H04W 28/02; H04W 76/20

(52) U.S. Cl. CPC H04L 41/5067; H04W 28/0268; H04W 76/20

(57) ABSTRACT

Presented are systems and methods for radio access network (RAN) visible quality of experience (QoE) measurement in dual connectivity architecture. A first network node of a radio access network (RAN) may generate a first configuration for at least one quality of experience (QoE) measurement that is to be utilized by the RAN. The first network node may send the first configuration to a wireless communication device to collect the at least one QoE measurement according to the first configuration.

### CROSS-REFERENCE TO RELATED APPLICATION

This application claims the benefit of priority under 35 U.S.C. § 120 as a continuation of PCT Patent Application No. PCT/CN2022/107472, filed on Jul. 22, 2022, the disclosure of which is incorporated herein by reference in its entirety.

### TECHNICAL FIELD

The disclosure relates generally to wireless communications, including but not limited to systems and methods for radio access network (RAN) visible quality of experience (QoE) measurement in dual connectivity architecture.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A first network node (e.g., a master node (MN) or a secondary node (SN)) of a radio access network (RAN) may generate a first configuration for at least one quality of experience (QoE) measurement that is to be utilized by the RAN (e.g., a RAN visible QoE configuration). The first network node may send the first configuration to a wireless communication device (e.g., a UE) to collect the at least one QoE measurement according to the first configuration.

In some embodiments, the first configuration may comprise at least one of: an identifier (id) of at least one QoE measurement to be utilized by an entity other than the RAN (e.g., QoE measurement that can be invisible to (or not for utilization by) the RAN), an id of the at least one QoE measurement utilized by the RAN, an indication of one or more nodes (e.g., a MN or a SN) of the RAN that is to utilize the at least one QoE measurement, an indication of at least one QoE metrics to include in the at least one QoE measurement, an indication of at least one QoE values to be determined from the at least one QoE metrics, an indication of an event to trigger the at least one QoE measurement, an indication of a priority of the at least one QoE measurement, an indication of a service type of the at least one QoE measurement, an indication of a collection interval for the at least one QoE measurement, or an indication of a reporting periodicity of the at least one QoE measurement.

In some embodiments, the first network node may send the first configuration to the wireless communication device via a radio resource control (RRC) message. The first network node may send the first configuration to a second network node (e.g., a MN or a SN) of the RAN. The wireless communication device may generate a report according to the at least one QoE measurement, according to the first configuration, wherein the report may comprise at least one of: an identifier (id) of at least one QoE measurement to be utilized by an entity other than the RAN (e.g., QoE measurement that can be invisible to (or not for utilization by) the RAN), an id of the at least one QoE measurement utilized by the RAN, an indication of at least one QoE metrics to include in the at least one QoE measurement, an indication of at least one QoE values to be determined from the at least one QoE metrics, an indication of one or more nodes (e.g., a MN or a SN) of the RAN that is to utilize the at least one QoE measurement, time stamp information of the at least one QoE measurement, quality of service (QOS) flow information of the at least one QoE measurement, or data radio bearer (DRB) list information of the at least one QoE measurement.

In some embodiments, the first network node may send the report to a second network node (e.g., a MN or a SN) of the RAN. The first network node may receive the report from a second network node (e.g., a MN or a SN) of the RAN.

In some embodiments, the first network node (e.g., a MN or a SN) may receive a second configuration generated by the second network node according to at least one requirement of the second network node from a second network node (e.g., a MN or a SN). The first network node of a radio access network (RAN) may generate the first configuration according to at least one of: the second configuration, or at least one requirement of the first network node. The first network node (e.g., MN) may receive a third configuration of QoE measurement to be utilized by an entity other than the RAN from a second network node of the RAN (e.g., QoE measurement that can be invisible to (or not for utilization by) the RAN).

In some embodiments, the first network node may generate a deactivate configuration to terminate the at least one QoE measurement, the deactivate configuration comprising at least one of: an identifier (id) of at least one QoE measurement to be utilized by an entity other than the RAN, an id of the at least one QoE measurement utilized by the RAN, or an indication of a service type of the at least one QoE measurement. The first network node may send the deactivate configuration to the wireless communication device via a radio resource control (RRC) message.

In some embodiments, the first network node may send a message to the second network node via an XnAP message, to indicate or request termination of the at least one QoE measurement. The first network node may receive a confirmation or acknowledgement message regarding the termination from the second network node. In certain embodiments, the first network node may comprise a secondary node (SN); and the second network node may comprise a master node (MN).

In some embodiments, the first network node may determine cell group information and signaling radio bearer (SRB) information, to be used for reporting at least one QoE measurement to be utilized by an entity other than the RAN. The first network node may send the SRB information to the second network node via a defined message or an Xn application protocol (XnAP) message. The cell group information may indicate whether a master cell group (MCG) or a secondary cell group (SCG) is to be used for reporting the at least one QoE measurement to be utilized by the RAN or an entity other than the RAN. The SCG information may indicate a type of SCG to be used for reporting the at least one QoE measurement to be utilized by the RAN or an entity other than the RAN.

In certain embodiments, the first network node may comprise a master node (MN); and the second network node may comprise a secondary node (SN).

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a sequence diagram for radio access network (RAN) visible quality of experience (QoE) measurement, in accordance with some embodiments of the present disclosure;

FIG. 4 illustrates a sequence diagram for radio access network (RAN) visible quality of experience (QoE) measurement, in accordance with some embodiments of the present disclosure;

FIG. 5 illustrates a sequence diagram for radio access network (RAN) visible quality of experience (QoE) measurement, in accordance with some embodiments of the present disclosure;

FIG. 6 illustrates a sequence diagram for terminating radio access network (RAN) visible quality of experience (QoE) measurement, in accordance with some embodiments of the present disclosure;

FIG. 7 illustrates a sequence diagram for quality of experience (QoE) configuration, in accordance with some embodiments of the present disclosure; and

FIG. 8 illustrates a flow diagram for radio access network (RAN) visible quality of experience (QoE) measurement, in accordance with an embodiment of the present disclosure.

### DETAILED DESCRIPTION

### 1. Mobile Communication Technology and Environment

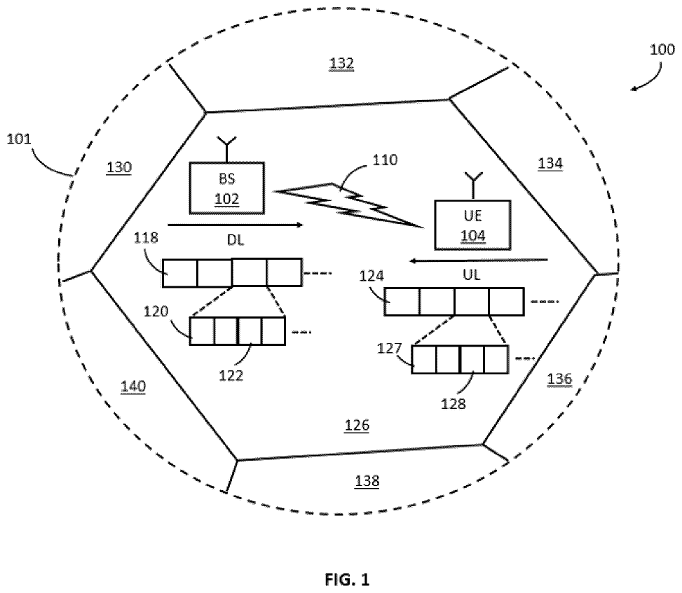

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

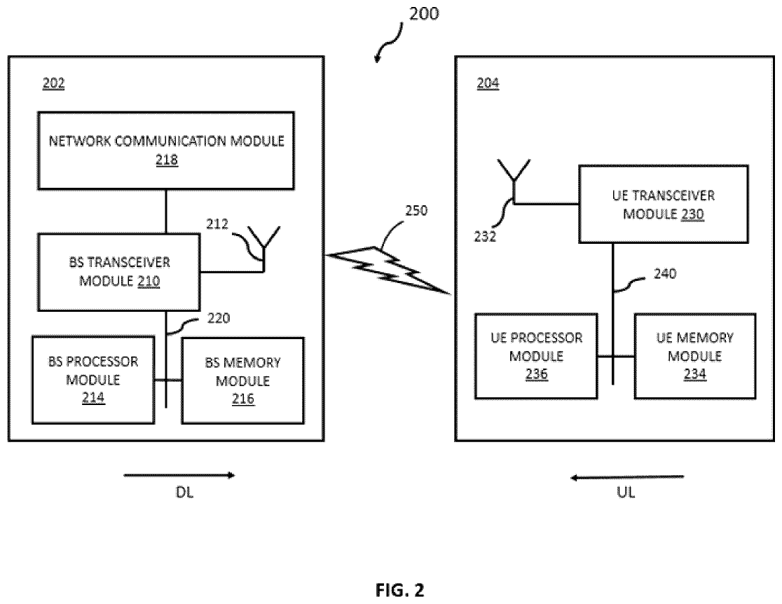

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Radio Access Network (RAN) Visible Quality of Experience (QoE) Measurement in Dual Connectivity Architecture

Quality of Experience (QoE) measurements can be configured to collect measurement results of certain service types in a user equipment (UE) application layer. A report of the QoE measurements can be transparent/invisible to a radio access network (RAN) node. A RAN visible QoE (e.g., referring to QoE info/measurement/report that is visible to a RAN entity and can be utilized by the RAN entity) can be a sub-feature which is configured on top of a QoE measurement (which may not be visible to a RAN entity, and is to be utilized by an entity other than a RAN entity). The RAN visible QoE can be configured if the QoE measurement for a certain service type is activated. However, QoE and RAN visible QoE can be only applied to standalone architecture or centralized unit (CU)-distributed unit (DU) split architecture in current techniques. This invention provides a technique for configuring and reporting of at least one RAN visible QoE in dual connectivity architecture.

New radio (NR) QoE measurement collection (QMC) function can be activated by an operations, administration and maintenance (OAM) via a separate QMC framework. For a signaling-based QoE, the QMC configuration for a specific UE can be sent from the OAM to a core network (CN), and the CN may send the QMC configuration to the RAN node via a UE-associated signaling (e.g., a NGAP/XnAP/FIAP message). For a management-based QoE, the OAM may send the QMC configuration to the RAN node. The RAN node may select UE(s) which satisfies the condition (e.g., area scope, slice, etc.) for the QoE measurement, and may send the QMC configuration to the UE(s).

For a QoE reporting in standalone architecture, a UE application layer may collect QoE metrics, and may send collected data according to the QoE metrics to a UE AS layer via an attention (AT) command. The UE AS layer may send the collected data (e.g., QoE reports) to the RAN node. After the RAN node receives the QoE reports, the RAN node may transfer/send the received QoE reports to a measurement collection entity (MCE). The MCE can be an entity which collects QoE measurement reports and performs analysis for optimization. The QoE reports can be transparent/invisible to the RAN node, which means the RAN node may not read and/or utilize the contents in the QoE reports.

A RAN visible QoE can be a sub-feature of QoE. The RAN can configure the RAN visible QoE based on its own requirements when a QoE measurement is activated. The RAN visible QoE may be associated with the QoE measurement by an id of the QoE measurement. The UE may collect RAN visible QoE measurement results, and may report the measurement results to the RAN node. The RAN node may use the measurement results for network optimizations. In centralized unit (CU)-distributed unit (DU) split architecture, the CU may transfer the RAN visible QoE measurement results to the DU via a FIAP message.

In a dual connectivity (DC), the UE can be connected to two RAN nodes. One of the RAN nodes may act as a master node (MN), and another one of the RAN nodes may act as a secondary node (SN). Both the MN and the SN can be configured with minimization of drive tests (MDT), and can collect MDT reports. The MDT can be activated via a trace function. The MDT reports can be sent to a trace collection entity (TCE). The QoE measurement reports can be sent to a measurement collection entity (MCE).

### Implementation Example 1: MN Generates a RAN Visible QoE Measurement Configuration

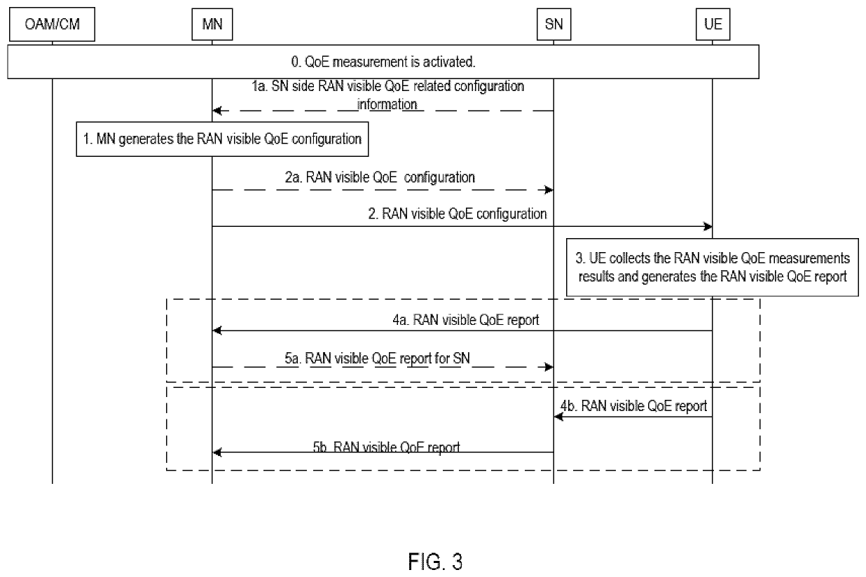

FIG. 3 illustrates a sequence diagram for radio access network (RAN) visible quality of experience (QoE) measurement in dual connectivity architecture.

In step 0, one or more QoE measurements can be activated in a dual connectivity (DC) architecture. One or more QoE configurations can be generated by an OAM/CN. The OAM/CN may send the QoE configuration(s) to a MN or a SN. For a management-based QoE, the QoE configuration can be directly sent by the OAM to the MN/SN. For a signaling-based QoE, the QoE configuration can be sent to the MN/SN via a core network (CN). After the MN or SN receives the QoE configuration(s), the MN or SN may transfer the QoE configuration(s) to a UE via a radio resource control (RRC) message. The UE may perform one or more QoE measurements in a UE application layer according to the received QoE configuration(s). The UE may report the QoE measurement results to a NG-RAN node (e.g., a MN or a SN). The MN or SN may forward the received QoE measurement results (e.g., a QoE report) to a MCE for QoE analysis. In some embodiments, the QoE report can be a transparent/invisible container to the RAN node, which means that the MN or SN (e.g., RAN entities) may be not able to read and/or utilize the information in the QoE report (e.g., to apply/process the information to perform or manage network optimization/improvement).

In step 1a (e.g., optional), the SN may generate RAN visible QoE related configuration information based on its own requirement. The SN may send the information to the MN via an Xn application protocol (XnAP) message (e.g., S-node modification required).

In step 1, the MN may generate a RAN visible configuration based on its own requirement and/or the received RAN visible QoE related configuration information from the SN. The RAN visible configuration may include configuration for multiple RAN visible QoE measurements. A QoE measurement/determination may involve gathering numerous parameters (e.g., encoding, transport, content, type of terminal, network, services infrastructure, media encoding, and/or user's expectations). QoE can be an important function for design of systems and engineering processes. The configuration for each RAN visible QoE measurement may include at least one of: an identifier (id) of at least one QoE measurement to be utilized by an entity other than the RAN (e.g., QoE measurement that can be invisible to (or not for utilization by) the RAN), an id of the at least one QoE measurement utilized by the RAN (e.g., a RAN visible QoE measurement id), an indication of one or more nodes (e.g., a MN or a SN) of the RAN that is to utilize the at least one QoE measurement, an indication of at least one QoE metrics to include in the at least one QoE measurement, an indication of at least one QoE values to be determined from the at least one QoE metrics, an indication of an event to trigger the at least one QoE measurement, an indication of a priority of the at least one QoE measurement, an indication of a service type of the at least one QoE measurement, an indication of a collection interval for the at least one QoE measurement, or an indication of a reporting periodicity of the at least one QoE measurement. The priority of the at least one QoE measurement may indicate which QoE measurement is more important among multiple QoE measurements. The service type of the at least one QoE measurement can include video streaming, web browsing, phone call, and/or TV broadcast. For example, video streaming services may require high traffic demands. QoE can be important for the video services. A bad network performance may highly affect a user's experience. The collection interval for the at least one QoE measurement can indicate a time domain granularity (e.g., a time unit or window used for collecting the QoE results). The reporting periodicity of the at least one QoE measurement can be a default value (e.g., hours or days) to report the QoE measurement to the MN and/or SN.

In step 2a (optional), the MN may send the complete RAN visible QoE configuration to the SN via an XnAP message (e.g., S-node modification confirm).

In step 2, the MN may send the RAN visible QoE configuration to UE via a RRC message.

In step 3, after the UE receives the RAN visible QoE configuration, the UE may collect/acquire a RAN visible QoE measurement result according to the corresponding QoE measurement in application layer. The UE may generate a RAN visible QoE measurement report. The RAN visible QoE report may include at least one of: an identifier (id) of at least one QoE measurement to be utilized by an entity other than the RAN (e.g., QoE measurement that can be invisible to (or not for utilization by) the RAN), an id of the at least one QoE measurement utilized by the RAN, at least one QoE metrics to include in the at least one QoE measurement, at least one QoE values to be determined from the at least one QoE metrics, an indication of one or more nodes (e.g., a MN or a SN) of the RAN that is to utilize the at least one QoE measurement, time stamp information of the at least one QoE measurement, quality of service (QOS) flow information of the at least one QoE measurement, or data radio bearer (DRB) list information of the at least one QoE measurement. The QoS flow information of the at least one QoE measurement can be based on technical measurements (e.g., access times, response times, or failure ratio).

In steps 4a-5a, the UE may send the RAN visible QoE report(s) to the MN. After the MN receives the RAN visible QoE report(s), the MN may decide/determine whether the RAN visible QoE report is to be used by the MN or the SN according to the information in the RAN visible QoE report. If the RAN visible QoE report is for the SN, the MN may forward the RAN visible QoE report/results to the SN via an XnAP message (e.g., S-node modification request).

In steps 4b-5b, the UE may send the RAN visible QoE report(s) to the SN. The SN may forward the RAN visible QoE report(s)/results to the MN if needed.

### Implementation Example 2: SN Generates a RAN Visible QoE Configuration

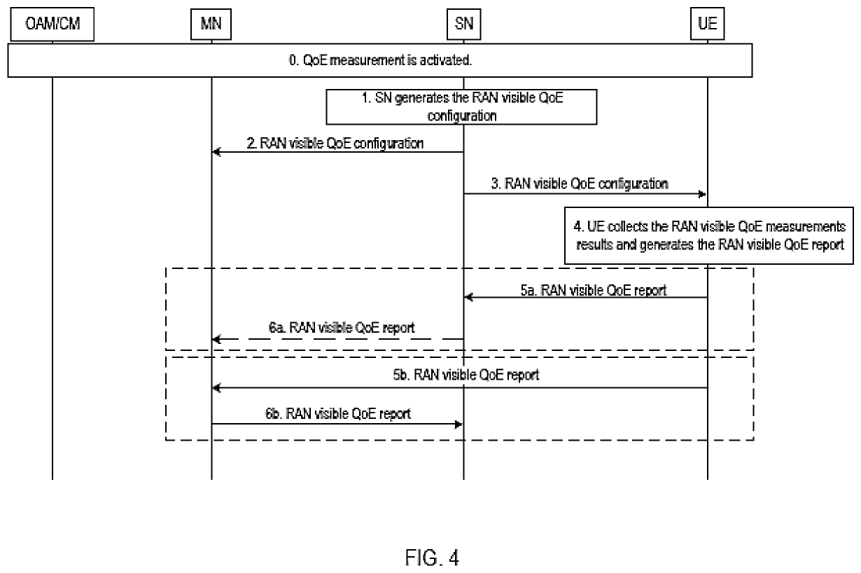

FIG. 4 illustrates a sequence diagram for radio access network (RAN) visible quality of experience (QoE) measurement (e.g., in dual connectivity architecture).

In step 0, one or more QoE measurements can be activated in a dual connectivity (DC) architecture. A QoE configuration can be generated by an OAM/CN. The OAM/CN may send the QoE configuration(s) to a MN or a SN. For a management-based QoE, the QoE configuration(s) can be directly sent by the OAM to the MN/SN. For a signaling-based QoE, the QoE configuration(s) can be sent to the MN/SN via a core network (CN). After the MN or SN receives the QoE configuration(s), the MN or SN may transfer the QoE configuration to a UE via a radio resource control (RRC) message. The UE may perform one or more QoE measurements in a UE application layer according to the received QoE configuration(s). The UE may report the QoE measurement results to a NG-RAN node (e.g., a MN or a SN). The MN or SN may forward the received QoE measurement results (e.g., a QoE report) to a MCE for QoE analysis.

In step 1, the SN may generate a RAN visible configuration based on its own requirement. The RAN visible QoE configuration might include a configuration for one or more RAN visible QoE measurements. A QoE measurement/determination may involve gathering numerous parameters (e.g., encoding, transport, content, type of terminal, network, services infrastructure, media encoding, and/or user's expectations). QoE can be an important metric for design of systems and engineering processes. The configuration for each RAN visible QoE measurement may include at least one of: an identifier (id) of at least one QoE measurement to be utilized by an entity other than the RAN (e.g., QoE measurement that can be invisible to (or not for utilization by) the RAN), an id of the at least one QoE measurement utilized by the RAN (e.g., a RAN visible QoE measurement id), an indication of one or more nodes (e.g., a MN or a SN) of the RAN that is to utilize the at least one QoE measurement, an indication of at least one QoE metrics to include in the at least one QoE measurement, an indication of at least one QoE values to be determined from the at least one QoE metrics, an indication of an event to trigger the at least one QoE measurement, an indication of a priority of the at least one QoE measurement, an indication of a service type of the at least one QoE measurement, an indication of a collection interval for the at least one QoE measurement, or an indication of a reporting periodicity of the at least one QoE measurement. The priority of the at least one QoE measurement may indicate which QoE measurement is more important among multiple QoE measurements. The service type of the at least one QoE measurement can include video streaming, web browsing, phone call, and/or TV broadcast. For example, video streaming services may require high traffic demands. QoE can be an important metric for the video services. A bad network performance may highly affect a user's experience. The collection interval for the at least one QoE measurement can indicate a time domain granularity (e.g., a time unit used for collecting the QoE results). The reporting periodicity of the at least one QoE measurement can be a default value (e.g., hours or days) to report the QoE measurement to the MN and/or SN.

In step 2, the SN may send the RAN visible QoE configuration to the MN via an XnAP message (e.g., S-node modification required).

In step 3, the SN may send the RAN visible QoE configuration to UE via a RRC message.

In step 4, after the UE receives the RAN visible QoE configuration, the UE may collect a RAN visible QoE measurement result according to the corresponding QoE measurement in UE application layer. The UE may generate a RAN visible QoE measurement report. The RAN visible QoE report may include at least one of: an identifier (id) of at least one QoE measurement to be utilized by an entity other than the RAN (e.g., QoE measurement that can be invisible to (or ignore by, and/or not for utilization by) the RAN), an id of the at least one QoE measurement utilized by the RAN, at least one QoE metrics to include in the at least one QoE measurement, at least one QoE values to be determined from the at least one QoE metrics, an indication of one or more nodes (e.g., a MN or a SN) of the RAN that is to utilize the at least one QoE measurement, time stamp information of the at least one QoE measurement, quality of service (QOS) flow information of the at least one QoE measurement, or data radio bearer (DRB) list information of the at least one QoE measurement. The QoS flow information of the at least one QoE measurement can be based on technical measurements (e.g., access times, response times, or failure ratio).

In steps 5a-6a, the UE may send the RAN visible QoE report(s) to the SN. After the SN receives the RAN visible QoE report(s), the SN may use the RAN visible QoE report(s) for network optimization. The SN may send the RAN visible QoE report(s)/results to the MN if needed.

In steps 5b-6b, the UE may send the RAN visible QoE report(s) to the MN. The MN may forward the RAN visible QoE report(s)/results to the SN. The SN may use the RAN visible QoE report for network optimization.

### Implementation Example 3: MN Triggers a RAN Visible QoE (RVQoE) on Top of SN Configured QoE

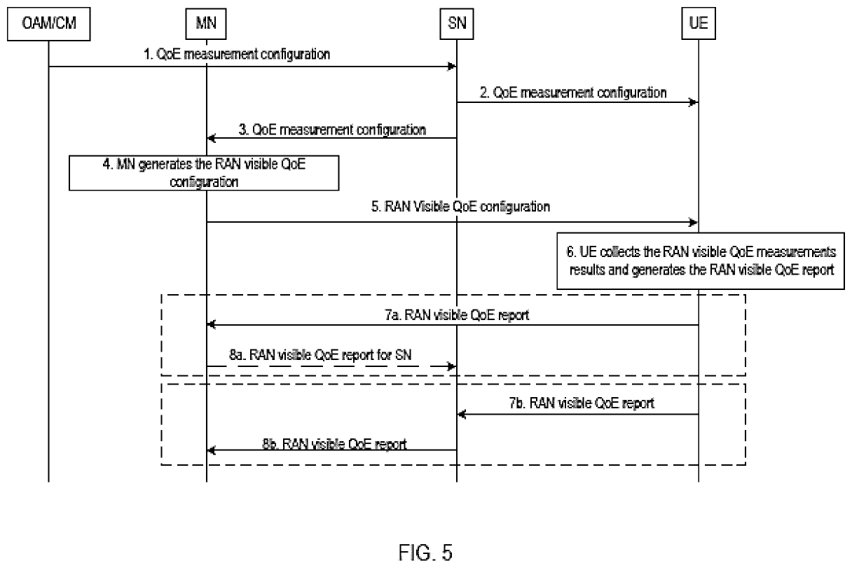

FIG. 5 illustrates a sequence diagram for radio access network (RAN) visible quality of experience (QoE) measurement (e.g., in dual connectivity architecture).

In step 1, the OAM or core network (CN) may transfer the QoE measurement configuration to the SN.

In step 2, the SN may send the QoE measurement configuration to the UE via a RRC message. The UE may start a measurement and reporting of QoE according to the received QoE measurement configuration.

In step 3, the SN may send the whole QoE configuration to the SN, or may partially send the configuration information to the SN (e.g., QoE Reference, MCE IP address, available QoE metrics, etc.).

In step 4, the MN may generate the RAN visible QoE configuration. The contents of the configuration can be the same as described in step 1 of implementation example 1. The configuration can be generated based on requirements of the MN and/or SN.

In step 5, the MN may send the RAN visible QoE configuration to the SN.

In step 6, after the UE receives the RAN visible QoE configuration, the UE may collect/acquire RAN visible QoE measurement results according to the corresponding QoE measurement in UE Application layer. The UE may generate a RAN visible QoE measurement report based on the RAN visible QoE measurement results. The RAN visible QoE report may include at least one of: an identifier (id) of at least one QoE measurement to be utilized by an entity other than the RAN (e.g., QoE measurement that can be invisible to (or ignored by and/or not for utilization by) the RAN), an id of the at least one QoE measurement utilized by the RAN, at least one QoE metrics to include in the at least one QoE measurement, at least one QoE values to be determined from the at least one QoE metrics, an indication of one or more nodes (e.g., a MN or a SN) of the RAN that is to utilize the at least one QoE measurement, time stamp information of the at least one QoE measurement, quality of service (QOS) flow information of the at least one QoE measurement, or data radio bearer (DRB) list information of the at least one QoE measurement. The QoS flow information of the at least one QoE measurement can be based on technical measurements (e.g., access times, response times, or failure ratio).

In steps 7a-8a, the UE may send the RAN visible QoE report(s) to the MN. After the MN receives the RAN visible QoE report, the MN may decide/determine whether the RAN visible QoE report is to be used/utilized by the MN or the SN according to the information in the RAN visible QoE report. If the RAN visible QoE report is for SN, the MN may forward the RAN visible QoE report/results to the SN via an XnAP message (e.g., S-node modification request).

In steps 7b-8b, the UE may send the RAN visible QoE report(s) to the SN. The SN may forward the RAN visible QoE report(s)/results to the MN if needed.

### Implementation Example 4: SN Triggers a Deactivation/Release of RAN Visible QoE Measurement

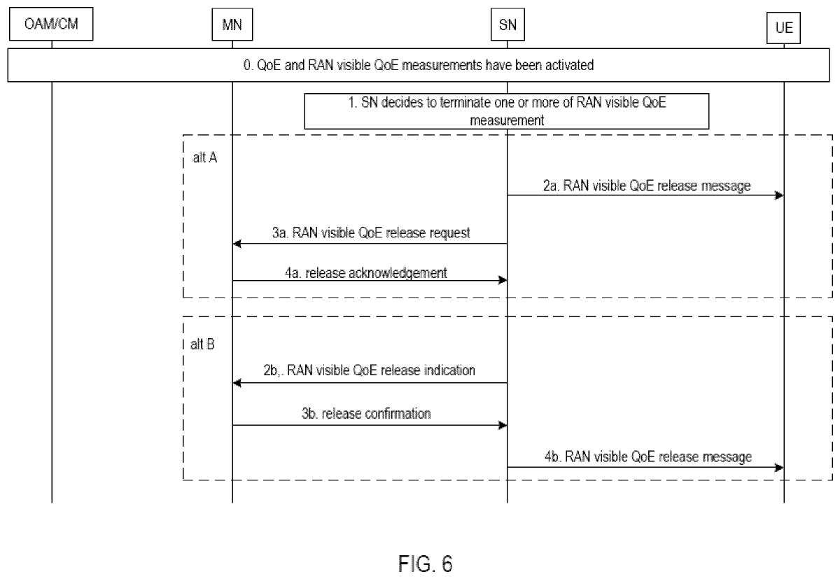

FIG. 6 illustrates a sequence diagram for terminating radio access network (RAN) visible quality of experience (QoE) measurement.

In step 0, a QoE measurement can be activated, e.g., in a dual connectivity (DC) architecture. A QoE configuration can be generated by an OAM/CN. The OAM/CN may send the QoE configuration to a MN or a SN. For a management-based QoE, the QoE configuration can be directly sent by the OAM to the MN/SN. For a signaling-based QoE, the QoE configuration can be sent to the MN/SN via a core network (CN). After the MN or SN receives the QoE configuration, the MN or SN may transfer the QoE configuration to a UE via a radio resource control (RRC) message. The UE may perform a QoE measurement in a UE application layer according to the received QoE configuration. The UE may report the QoE measurement results to a NG-RAN node (e.g., a MN or a SN). The MN or SN may forward the received QoE measurement results (e.g., a QoE report) to a MCE for QoE analysis. In some embodiment, the QoE report can be a container that is transparent/invisible to the RAN node, which means the MN or SN may be not able to inspect/read/utilize the information in the QoE report.

In step 1, the SN may decide to deactivate/release/terminate/discontinue one or more RAN visible QoE measurements, and may generate a deactivate configuration for RAN visible QoE. The deactivate configuration may include the configuration for one or more RAN visible QoE measurements which may be configured to UE. The deactivate configuration (e.g., similar to the configuration for each RAN visible QoE measurement) can include at least one of: an identifier (id) of at least one QoE measurement to be utilized by an entity other than the RAN, an id of the at least one QoE measurement utilized by the RAN, or an indication of a service type of the at least one QoE measurement.

### Alternative A

In step 2a, the SN may send the deactivate configuration for RAN visible QoE to the UE via a RRC message, to release the RAN visible QoE measurement in the UE. After the UE receives the deactivation message for RAN visible QoE, the UE may release/expire/inactivate the configuration for the corresponding RAN visible QoE, and may stop the collecting and reporting of the corresponding RAN visible QoE.

In step 3a, the SN may notify the deactivation/release of the RAN visible QoE to the MN via an XnAP message (e.g., S-node modification required).

In step 4a, the MN may send an acknowledgement to the SN about the release/deactivation of RAN visible QoE by the SN via an XnAP message (e.g., S-node modification confirm).

### Alternative B

In step 2b, the SN may send requirements of releasing/deactivating one or more of the RAN visible QoE measurement to the MN via an XnAP message (e.g. S-node modification required).

In step 3b, the MN may confirm the requirements from SN and may send the confirmation to the SN via an XnAP message (e.g., S-node modification confirm).

In step 4b, after the SN receives the confirmation from the MN, the SN may send the deactivation configuration to the UE, to release the RAN visible QoE measurement in the UE. After the UE receives the deactivation message for RAN visible QoE, the UE may release the configuration for the corresponding RAN visible QoE, and may stop collecting and reporting of the corresponding RAN visible QoE.

### Implementation Example 5: MN Sends Signaling Radio Bearer (SRB) Information to SN

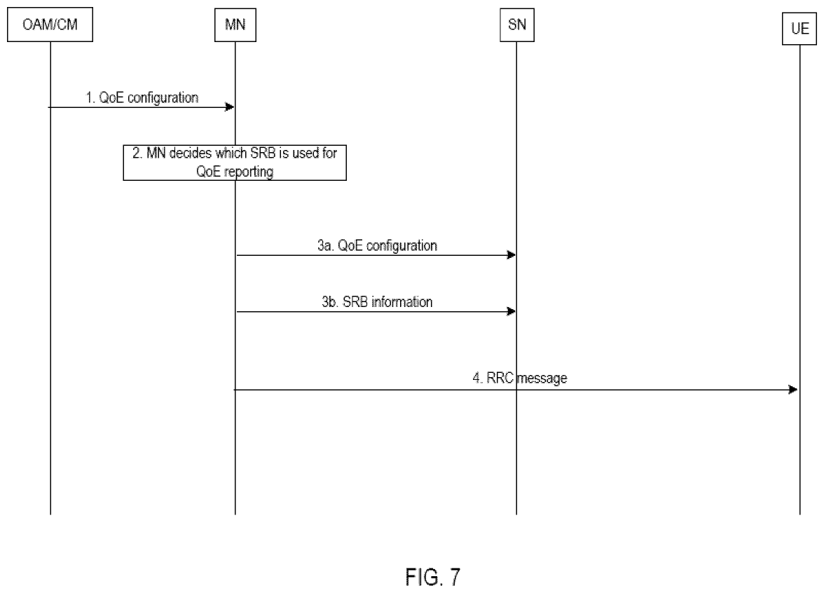

FIG. 7 illustrates a sequence diagram for quality of experience (QoE) configuration (e.g., in dual connectivity architecture).

In step 1, the OAM or CN may transfer a QoE configuration to the MN.

In step 2, the MN may decide/determine which leg is used for QoE reporting (e.g., master cell group (MCG) or secondary cell group (SCG)), and signaling radio bearer (SRB) to be used for QoE reporting (e.g., SRB3, split SRB). A SRB can be a type of radio bearer that carries signaling message (e.g., a RRC or/and NAS message), and can be of various possible types. For instance, SRB3 can be for specific RRC messages when a UE is in E-UTRA NR Dual connectivity (EN-DC), all using dedicated control channel (DCCH) logical channel.

In step 3a, the MN may send the whole QoE configuration to the SN, or may partially send the configuration information to the SN (e.g., QoE Reference, MCE IP address, available QoE metrics, etc.).

In step 3b, the MN send the SRB information (decided/determined in step 2) to the SN via a current/defined message (e.g., S-node addition request or S-node modification request) or a (new) XnAP message. An example of IE structure of the SRB information is shown in

### Table 1.

TABLE 1

| IE/Group | | | IE type and | Semantics | | Assigned |
|---|---|---|---|---|---|---|
| Name | Presence | Range | reference | description | Criticality | Criticality |
| Requested | O | | ENUMERATED | Indicates | Yes | Ignore |
| Split SRB for | | | (srb1, srb2, srb4, | that | | |
| QoE reporting | | | srb1&2&4, . . . ) | resources | | |
| | | | | for Split | | |
| | | | | SRBs are | | |
| | | | | requested | | |
| | | | | for QoE | | |
| | | | | reporting | | |

The IE can be a revision of a current/predefined IE in XnAP or a newly defined IE. In some embodiments, step 3a and step 3b can be performed using different messages or the same message.

In step 4, the MN may transfer the QoE configuration to the UE via a RRC message. The UE may send QoE reports via a corresponding SRB.

It should be understood that one or more features from the above and following implementation examples are not exclusive to the specific implementation examples, but can be combined in any manner (e.g., in any priority and/or order, concurrently or otherwise).

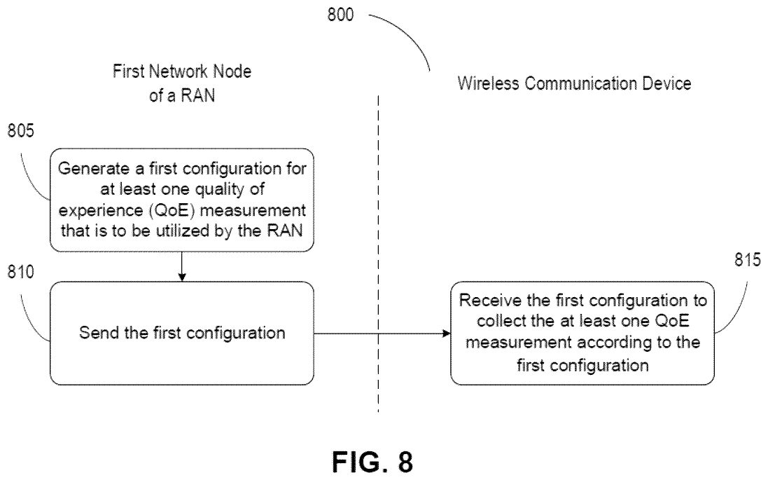

FIG. 8 illustrates a flow diagram of a method 800 for radio access network (RAN) visible quality of experience (QoE) measurement (e.g., in dual connectivity architecture). The method 800 may be implemented using any one or more of the components and devices detailed herein in conjunction with FIGS. 1-2. In brief overview, the method 800 may be performed by a first network node of a RAN, in some embodiments. Additional, fewer, or different operations may be performed in the method 800 depending on the embodiment. At least one aspect of the operations is directed to a system, method, apparatus, or a computer-readable medium.

A first network node (e.g., a master node (MN) or a secondary node (SN)) of a radio access network (RAN) may generate a first configuration for at least one quality of experience (QoE) measurement that is to be utilized by the RAN (e.g., a RAN visible QoE configuration). The first network node may send the first configuration to a wireless communication device (e.g., a UE) to collect the at least one QoE measurement according to the first configuration.

In some embodiments, the first configuration may comprise at least one of: an identifier (id) of at least one QoE measurement to be utilized by an entity other than the RAN (e.g., QoE measurement that can be invisible to (or not for utilization by) the RAN), an id of the at least one QoE measurement utilized by the RAN, an indication of one or more nodes (e.g., a MN or a SN) of the RAN that is to utilize the at least one QoE measurement, an indication of at least one QoE metrics to include in the at least one QoE measurement, an indication of at least one QoE values to be determined from the at least one QoE metrics, an indication of an event to trigger the at least one QoE measurement, an indication of a priority of the at least one QoE measurement, an indication of a service type of the at least one QoE measurement, an indication of a collection interval for the at least one QoE measurement, or an indication of a reporting periodicity of the at least one QoE measurement.

In some embodiments, the first network node may send the first configuration to the wireless communication device via a radio resource control (RRC) message. The first network node may send the first configuration to a second network node (e.g., a MN or a SN) of the RAN. The wireless communication device may generate a report according to the at least one QoE measurement, according to the first configuration, wherein the report may comprise at least one of: an identifier (id) of at least one QoE measurement to be utilized by an entity other than the RAN (e.g., QoE measurement that can be invisible to (or not for utilization by) the RAN), an id of the at least one QoE measurement utilized by the RAN, at least one QoE metrics to include in the at least one QoE measurement, at least one QoE values to be determined from the at least one QoE metrics, an indication of one or more nodes (e.g., a MN or a SN) of the RAN that is to utilize the at least one QoE measurement, time stamp information of the at least one QoE measurement, quality of service (QoS) flow information of the at least one QoE measurement, or data radio bearer (DRB) list information of the at least one QoE measurement.

In some embodiments, the first network node may send the report to a second network node (e.g., a MN or a SN) of the RAN. The first network node may receive the report from a second network node (e.g., a MN or a SN) of the RAN.

In some embodiments, the first network node (e.g., a MN or a SN) may receive a second configuration generated by the second network node according to at least one requirement of the second network node from a second network node (e.g., a MN or a SN). The first network node of a radio access network (RAN) may generate the first configuration according to at least one of: the second configuration, or at least one requirement of the first network node. The first network node (e.g., MN) may receive a third configuration of QoE measurement to be utilized by an entity other than the RAN from a second network node of the RAN (e.g., QoE measurement that can be invisible to (or not for utilization by) the RAN).

In some embodiments, the first network node may generate a deactivate configuration to terminate the (process of acquiring/performing the) at least one QoE measurement, the deactivate configuration comprising at least one of: an identifier (id) of at least one QoE measurement to be utilized by an entity other than the RAN, an id of the at least one QoE measurement utilized by the RAN, or an indication of a service type of the at least one QoE measurement. The first network node may send the deactivate configuration to the wireless communication device via a radio resource control (RRC) message.

In some embodiments, the first network node may send a message to the second network node via an XnAP message, to indicate or request termination of the (process of acquiring/performing the) at least one QoE measurement. The first network node may receive a confirmation or acknowledgement message regarding the termination from the second network node. In certain embodiments, the first network node may comprise a secondary node (SN); and the second network node may comprise a master node (MN).

In some embodiments, the first network node may determine cell group information and signaling radio bearer (SRB) information, to be used for reporting at least one QoE measurement to be utilized by an entity other than the RAN. The first network node may send the SRB information to the second network node via a defined message or an Xn application protocol (XnAP) message. The cell group information may indicate whether a master cell group (MCG) or a secondary cell group (SCG) is to be used for reporting the at least one QoE measurement to be utilized by the RAN or an entity other than the RAN. The SCG information may indicate a type of SCG to be used for reporting the at least one QoE measurement to be utilized by the RAN or an entity other than the RAN.

In certain embodiments, the first network node may comprise a master node (MN); and the second network node may comprise a secondary node (SN).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
generating, by a first network node of a radio access network (RAN), a first configuration for at least one quality of experience (QoE) measurement that is to be utilized by the RAN; and
sending, by the first network node, the first configuration to a wireless communication device to collect the at least one QoE measurement according to the first configuration.

2. The method of claim 1, wherein the first configuration comprises at least one of:
an identifier (id) of at least one QoE measurement to be utilized by an entity other than the RAN,
an id of the at least one QoE measurement utilized by the RAN,
an indication of one or more nodes of the RAN that is to utilize the at least one QoE measurement,
an indication of at least one QoE metrics to include in the at least one QoE measurement,
an indication of at least one QoE values to be determined from the at least one QoE metrics,
an indication of an event to trigger the at least one QoE measurement,
an indication of a priority of the at least one QoE measurement,
an indication of a service type of the at least one QoE measurement,
an indication of a collection interval for the at least one QoE measurement, or
an indication of a reporting periodicity of the at least one QoE measurement.

3. The method of claim 1, comprising:
sending, by the first network node, the first configuration to the wireless communication device via a radio resource control (RRC) message.

4. The method of claim 1, comprising:
sending, by the first network node, the first configuration to a second network node of the RAN.

5. The method of claim 1, wherein the wireless communication device generates a report according to the at least one QoE measurement, according to the first configuration,
wherein the report comprises at least one of:
an identifier (id) of at least one QoE measurement to be utilized by an entity other than the RAN,
an id of the at least one QoE measurement utilized by the RAN,
an indication of at least one QoE metrics to include in the at least one QoE measurement,
an indication of at least one QoE values to be determined from the at least one QoE metrics,
an indication of one or more nodes of the RAN that is to utilize the at least one QoE measurement,
time stamp information of the at least one QoE measurement,
quality of service (QOS) flow information of the at least one QoE measurement, or
data radio bearer (DRB) list information of the at least one QoE measurement.

6. The method of claim 5, comprising:
sending, by the first network node, the report to a second network node of the RAN.

7. The method of claim 5, comprising:
receiving, by the first network node, the report from a second network node of the RAN.

8. The method of claim 1, comprising:
receiving, by the first network node from a second network node, a second configuration generated by the second network node according to at least one requirement of the second network node; and
generating, by the first network node of a radio access network (RAN), the first configuration according to at least one of: the second configuration, or at least one requirement of the first network node.

9. The method of claim 1, comprising:
receiving, by the first network node from a second network node of the RAN, a third configuration of QoE measurement to be utilized by an entity other than the RAN.

10. The method of claim 1, comprising at least one of:
generating, by the first network node, a deactivate configuration to terminate the at least one QoE measurement, the deactivate configuration comprising at least one of:
an identifier (id) of at least one QoE measurement to be utilized by an entity other than the RAN,
an id of the at least one QoE measurement utilized by the RAN, or
an indication of a service type of the at least one QoE measurement; or
sending, by the first network node, the deactivate configuration to the wireless communication device via a radio resource control (RRC) message.

11. The method of claim 1, comprising at least one of:
sending, by the first network node, a message to the second network node via an XnAP message, to indicate or request termination of the at least one QoE measurement, or
receiving, by the first network node from the second network node, a confirmation or acknowledgement message regarding the termination.

12. The method of claim 1, wherein the first network node comprises a secondary node (SN); and the second network node comprises a master node (MN).

13. The method of claim 1, comprising:
determining, by the first network node, cell group information and signaling radio bearer (SRB) information, to be used for reporting at least one QoE measurement to be utilized by an entity other than the RAN; and
sending, by the first network node, the SRB information to the second network node via a defined message or an Xn application protocol (XnAP) message.

14. The method of claim 13, wherein at least one of:
the cell group information indicates whether a master cell group (MCG) or a secondary cell group (SCG) is to be used for reporting the at least one QoE measurement to be utilized by the RAN or an entity other than the RAN, or
the SCG information indicates a type of SCG to be used for reporting the at least one QoE measurement to be utilized by the RAN or an entity other than the RAN.

15. The method of claim 1, wherein the first network node comprises a master node (MN); and the second network node comprises a secondary node (SN).

16. A method comprising:
receiving, by a wireless communication device from a first network node of a radio access network (RAN), a first configuration to collect the at least one QoE measurement according to the first configuration,
wherein the first configuration is generated for at least one quality of experience (QoE) measurement that is to be utilized by the RAN.

17. A wireless communication device, comprising:
at least one processor configured to:
receive, via a receiver from a first network node of a radio access network (RAN), a first configuration to collect the at least one QoE measurement according to the first configuration,
wherein the first configuration is generated for at least one quality of experience (QoE) measurement that is to be utilized by the RAN.

18. A first network node of a radio access network (RAN), comprising:
at least one processor configured to:
generate a first configuration for at least one quality of experience (QoE) measurement that is to be utilized by the RAN; and
send, via a transmitter, the first configuration to a wireless communication device to collect the at least one QoE measurement according to the first configuration.

19. The first network node of claim 18, wherein the first configuration comprises at least one of:
an identifier (id) of at least one QoE measurement to be utilized by an entity other than the RAN,
an id of the at least one QoE measurement utilized by the RAN,
an indication of one or more nodes of the RAN that is to utilize the at least one QoE measurement,
an indication of at least one QoE metrics to include in the at least one QoE measurement,
an indication of at least one QoE values to be determined from the at least one QoE metrics,
an indication of an event to trigger the at least one QoE measurement,
an indication of a priority of the at least one QoE measurement,
an indication of a service type of the at least one QoE measurement,
an indication of a collection interval for the at least one QoE measurement, or
an indication of a reporting periodicity of the at least one QoE measurement.

20. The first network node of claim 18, wherein the at least one processor is configured to:
send, via a transmitter, the first configuration to the wireless communication device via a radio resource control (RRC) message.
